(19) United States
(12) Patent Application Publication
(10) Pub. No.: US 2013/0294984 A1
(43) Pub. Date: Nov. 7, 2013

(54) Radiochemical Synthesis Apparatus Using Spatial Temperature Manipulation

(71) Applicant: Jianzhong Zhang, Brea, CA (US)

(72) Inventor: Jianzhong Zhang, Brea, CA (US)

(21) Appl. No.: 13/870,354

(22) Filed: Apr. 25, 2013

Related U.S. Application Data
(60) Provisional application No. 61/641,053, filed on May 1, 2012.

(51) Int. Cl. B01J 19/24

(52) U.S. Cl. CPC B01J 19/24
USPC 422/558; 422/159

(57) ABSTRACT

A compact and flexible apparatus that may be used to carry out multistep chemical or radiochemical synthesis is disclosed. Radiochemical tracers may be synthesized through a spatial temperature manipulation approach. The reaction vessel and the reagent vials can be removed after a single use, suggesting the apparatus can be used multiple times a day.

### RELATED APPLICATION

This application claims priority to U.S. Provisional Application No. 61/641,053 filed May 1, 2012, the contents of which is hereby incorporated in its entirety by reference.

### FIELD OF THE INVENTION

The present invention relates to a chemical synthesis apparatus in general and a radiochemical synthesis apparatus in particular.

### BACKGROUND OF THE INVENTION

Positron emission tomography (PET) is a nuclear medical imaging system that scans a body and creates a three-dimensional image of functional processes in the body. The system detects gamma rays emitted by a positron-emitting radioisotope, which is usually labeled through radiochemical synthesis on a biologically active molecule, or compound, to form a tracer. The tracer is introduced into the body. Three-dimensional images of tracer distribution within the body are then constructed by computer analysis.

The most commonly used PET tracer is fludeoxyglucose (FDG), an analogue of glucose. The distribution of FDG in the body is an indication of tissue metabolic activity by virtue of glucose uptake. So the PET scan of FDG can be used for abnormal metabolic diagnosis or early cancer detection. However, based on specific needs, many new biological active compounds are investigated in research facilities worldwide. Due to the short half-life of radioisotopes (109.8 minutes for fluorine-18, for example) and the diversity of the biological active compounds, the radiochemical synthesis of these tracers needs to be fast and flexible, whether is based on macro-scale reactor or micro-fluidics.

Chemical or radiochemical synthesis involves both energy transfer and mass transfer processes. Typical radiochemical synthesis systems comprises a reaction vessel 102, which is fixed on top of a temperature manipulating element 112, and is surrounded by a number of mass transfer lines 120 (FIG. 1a). There are limitations associated with these radiochemical synthesis systems.

First, the energy transfer, which is usually in the form of a series of temperature transitions, is hardly a fast and efficient process for radiochemical synthesis. Ideally, temperature transition is instantaneous and then temperature stays at a pre-determined setting (130, FIG. 1b). In reality, temperature transition takes time and is followed by a period of temperature fluctuation (132, FIG. 1b). Shorter transition time is achieved by higher heating power, which in turn generates more temperature fluctuation. Moreover, the temperature manipulating element is usually a big mass itself, which takes extra energy and extra time in temperature transition. New technologies, such as microwave and infrared, may improve the heating efficiency. Unfortunately, these devices are bulky, expensive and complex.

Second, the immobilization of the reaction vessel and the structure of multiple mass transfer lines make the system inflexible. Meanwhile, heavy use of liquid valves and metering devices in mass transfer lines makes the system expensive, complex and unreliable. Such systems are usually designed to synthesize a few tracers, even a single tracer. It is nearly impossible for such systems to synthesize a wide range of radiochemical products without substantial system modification.

For the foregoing reasons, there is a need for a fast and flexible radiochemical synthesis apparatus with improved energy and mass transfer efficiency.

### SUMMARY OF THE INVENTION

The present invention discloses an apparatus that carries out multistep chemical or radiochemical processes through a spatial temperature manipulation approach. The apparatus comprises a reaction stage and a reagent stage. The reaction stage comprises a reaction vessel, a plurality of preconditioned temperature manipulating elements and a moving means. The moving means accommodates the reaction vessel and programmatically moves the reaction vessel to reach the preconditioned temperature manipulating elements. Each movement is equivalent to a step in radiochemical process. The whole radiochemical synthesis process can be automated. The reaction vessel can be removed after a single use, suggesting the apparatus can perform multiple runs a day. These and other features and advantages of the present invention will become better understood with reference to the following drawings, description and claims.

### BRIEF DESCRIPTION OF THE DRAWINGS

The details of the present invention, both its structure and operation, may be gleaned in part by the accompanying drawings, in which like reference numbers refer to like parts and arrows refer to movement directions of moving components, and in which:

FIG. 1 illustrates a traditional chemical or radiochemical apparatus and temperature manipulation processes;

FIG. 2 illustrates an embodiment of the reaction stage of the apparatus;

FIG. 3 illustrates another embodiment of the reaction stage of the apparatus;

FIG. 4 illustrates yet another embodiment of the reaction stage of the apparatus;

FIG. 5 shows the detail of a filling element;

FIG. 6 shows the detail of an evaporation element;

FIG. 7 shows the detail of a reaction element;

FIG. 8 shows the detail of a retrieving element;

FIG. 9 shows the detail of a vessel removing element; and

FIG. 10 illustrates an embodiment of a reagent stage and the connection to a reaction vessel.

### DETAILED DESCRIPTION

A radiochemical synthesis needs a radioisotope and at least one reagent. A radiochemical synthesis may involve one or more reaction steps, generating a radioactive intermediate or a radiochemical product, which may be purified as a tracer. The present invention is directed to an apparatus that may be used to carry out multistep chemical or radiochemical processes. The apparatus comprises a reaction stage and a reagent stage. The reaction stage of the apparatus comprises a reaction vessel, a plurality of preconditioned temperature manipulating elements and a moving means. The moving means accommodates the reaction vessel and programmatically moves the reaction vessel to reach the preconditioned temperature manipulating elements using a step motor or similar device. Each movement is equivalent to a step in radiochemical process. The whole radiochemical process can be automated. This invention may be embodied in many different forms and should not be construed as limited to the embodiments set forth herein. Rather, these embodiments are provided to ensure that this disclosure is thorough and complete, and to ensure that it fully conveys the scope of the invention to those skilled in the art.

The term “preconditioned” means certain condition is established before a particular operation. The term “preconditioned” also means certain material is prefilled before a particular operation. A preconditioned temperature manipulating element, for example, is an element that is preheated to a predetermined temperature before a reaction vessel reaches the element. To make temperature transition in a reaction vessel, simply move the reaction vessel to reach a preconditioned temperature manipulating element, or move the reaction vessel between two preconditioned temperature manipulating elements. Because the temperature manipulating element is preconditioned or preheated, the heating of the reaction vessel is faster than heating both the reaction vessel and the temperature manipulating element together. The heating is also more stable, considering the temperature fluctuation only occurs during the temperature transition, or at early stage of preconditioning.

In instrument design, people believe “less means more”. This invention, however, shows that sometimes the opposite is true. The use of more than one temperature manipulation element simplifies the design and operation. The use of low power heaters, as required to precondition the temperature manipulating element, also reduces the size of the apparatus.

With the combination of a plurality of preconditioned temperature manipulating elements and a moving means, temperature manipulation is no longer a traditional temporal process. It is rather a spatial process. The spatial temperature manipulation provides speed and stability. It should be noted that the same principle applies to fast cooling—simply move a hot reaction vessel to reach a preconditioned cooling element. Fast cooling of the reaction vessel can also be achieved by forced air after separating the preconditioned temperature manipulating element from the reaction vessel.

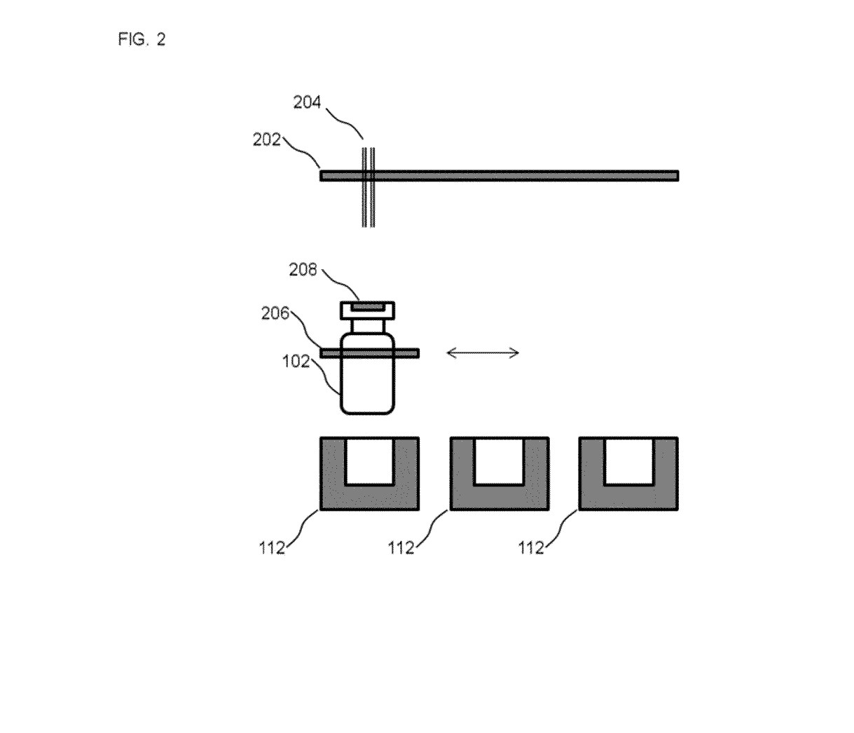

Referring to FIG. 2, one embodiment of the reaction stage disclosed herein comprises a reaction vessel 102, a plurality of preconditioned temperature manipulating elements 112, an evaporating element 204, and a first moving means 206. The first moving means 206 is to accommodate the reaction vessel 102 and to move the reaction vessel 102 along a track to reach the elements 112 and 204 to perform the following: 1) to dry, evaporate or concentrate the content in the reaction vessel 102 using one of the preconditioned temperature manipulating elements 112; 2) to perform a radiochemical reaction in the reaction vessel 102 using another one of the preconditioned temperature manipulating elements 112, generating a radiochemical product or a radioactive intermediate; and 3) to perform a further radiochemical reaction in the reaction vessel 102 using yet another one of the preconditioned temperature manipulating elements 112, turning the radioactive intermediate into a radiochemical product. The elements 112 and 204 are placed along the track. The track can be straight, circular or other form. The track can be visible or invisible. The reaction vessel 102 may be sealed with a pierceable member 208.

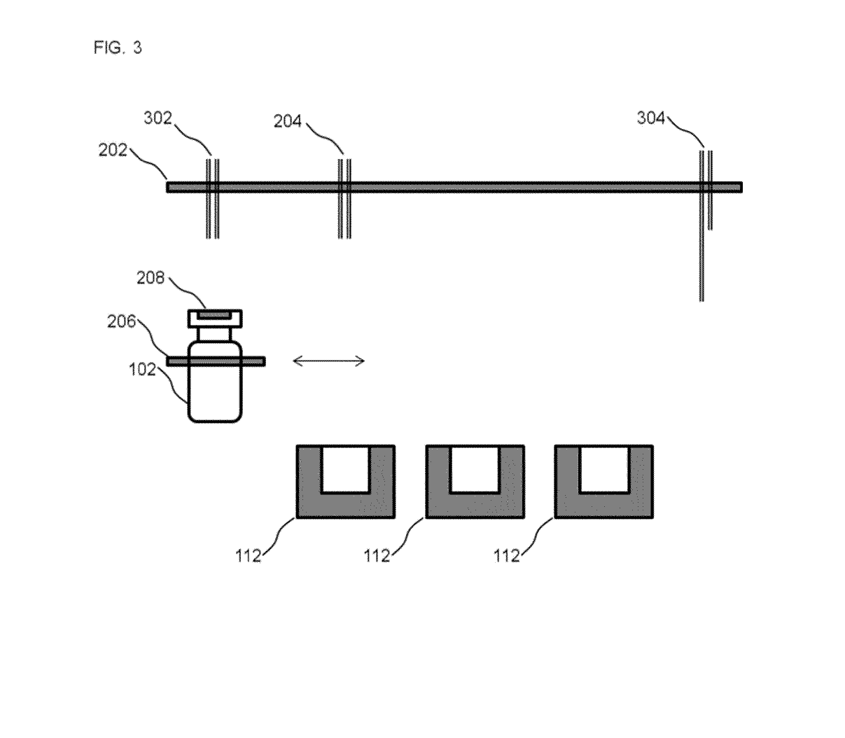

Referring to FIG. 3, another embodiment of the reaction stage disclosed herein comprises a reaction vessel 102, a plurality of preconditioned temperature manipulating elements 112, an evaporating element 204, one or more filling elements 302, one or more retrieving elements 304, and a first moving means 206. The first moving means 206 is to accommodate the reaction vessel 102 and to move the reaction vessel 102 along a track to reach the elements 112, 204, 302 and 304 to perform the following: 1) to fill a radioisotope and at least one reagent into the reaction vessel 102; 2) to dry, evaporate or concentrate the content in the reaction vessel 102 using one of the preconditioned temperature manipulating elements 112; 3) to perform a radiochemical reaction in the reaction vessel 102 using another one of the preconditioned temperature manipulating elements 112, generating a radiochemical product or a radioactive intermediate; 4) to perform a further radiochemical reaction in the reaction vessel 102 using yet another one of the preconditioned temperature manipulating elements 112, turning the radioactive intermediate into a radiochemical product; and 5) to retrieve the radiochemical product or the radioactive intermediate from the reaction vessel 102. The elements 112, 204, 302 and 304 are placed along the track. The track can be straight, circular or other form. The track can be visible or invisible. The reaction vessel 102 may be sealed with a pierceable member 208.

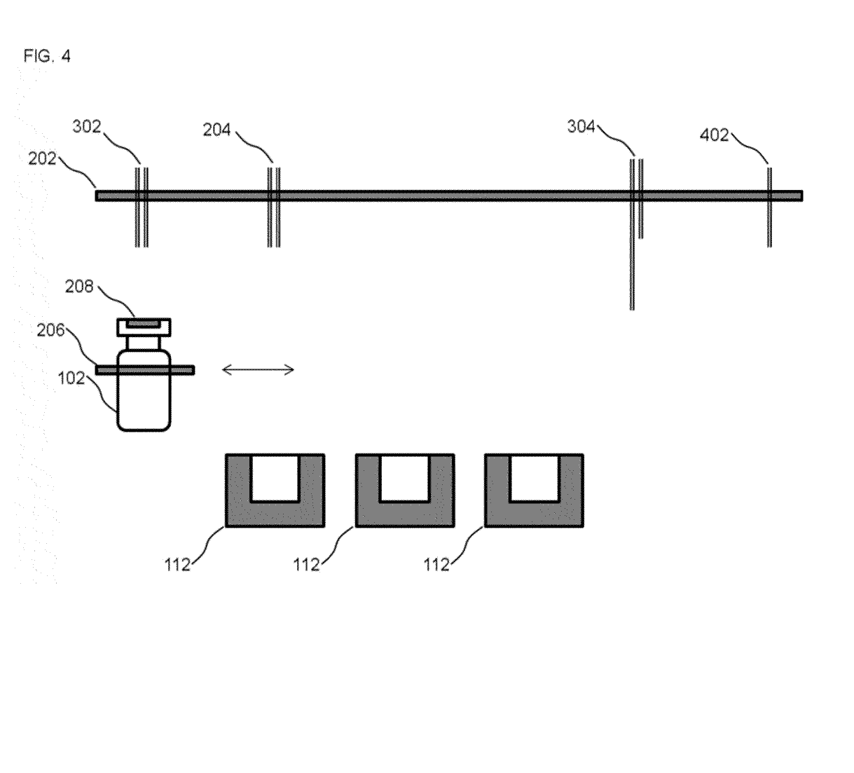

Referring to FIG. 4, yet another embodiment of the reaction stage disclosed herein comprises a reaction vessel 102, a plurality of preconditioned temperature manipulating elements 112, an evaporating element 204, one or more filling elements 302, one or more retrieving elements 304, a vessel removing element 402, and a first moving means 206. The first moving means 206 is to accommodate the reaction vessel 102 and to move the reaction vessel 102 along a track to reach the elements 112, 204, 302, 304 and 402 to perform the following: 1) to fill a radioisotope and at least one reagent into the reaction vessel 102; 2) to dry, evaporate or concentrate the content in the reaction vessel 102 using one of the preconditioned temperature manipulating elements 112; 3) to perform a radiochemical reaction in the reaction vessel 102 using another one of the preconditioned temperature manipulating elements 112, generating a radiochemical product or a radioactive intermediate; 4) to perform a further radiochemical reaction in the reaction vessel 102 using yet another one of the preconditioned temperature manipulating elements 112, turning the radioactive intermediate into a radiochemical product; 5) to retrieve the radiochemical product or the radioactive intermediate from the reaction vessel 102; and 6) to remove the reaction vessel 102. The elements 112, 204, 302, 304 and 402 are placed along the track. The track can be straight, circular or other form. The track can be visible or invisible. The reaction vessel 102 may be sealed with a pierceable member 208. The reaction vessel 102 can be removed with the vessel removing element 402.

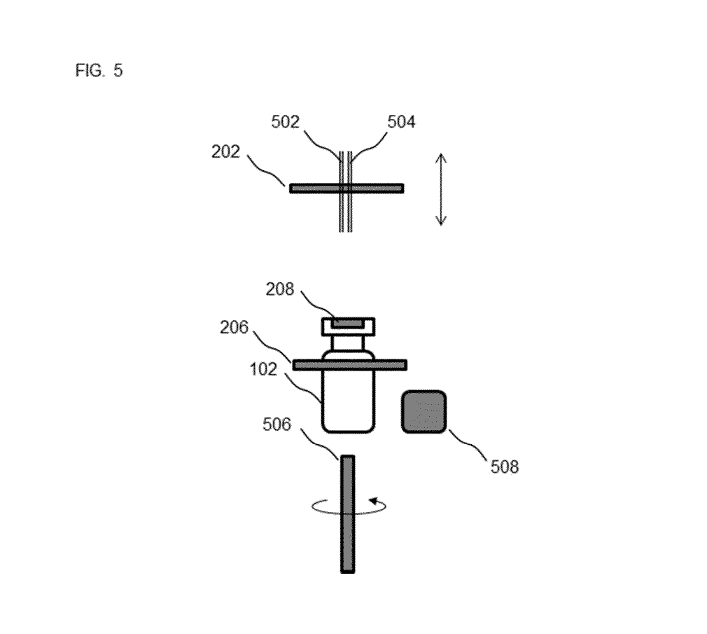

Referring to FIG. 5, the filling element 302 comprises a sealing member 202, an inlet needle 502, and an outlet needle 504. To fill the reaction vessel 102 with either a radioisotope or at least one reagent, lower the sealing member 202 to seal the reaction vessel 102, fill either the radioisotope or the at least one reagent through the inlet needle 502 and push air out through the outlet needle 504. A mixer 506 is positioned below the reaction vessel 102 and a radiation detector 508 is positioned on the side of the reaction vessel 102. The mixer 506 provides mixing needs while the radiation detector 508 monitors the radioactivity in the reaction vessel 102.

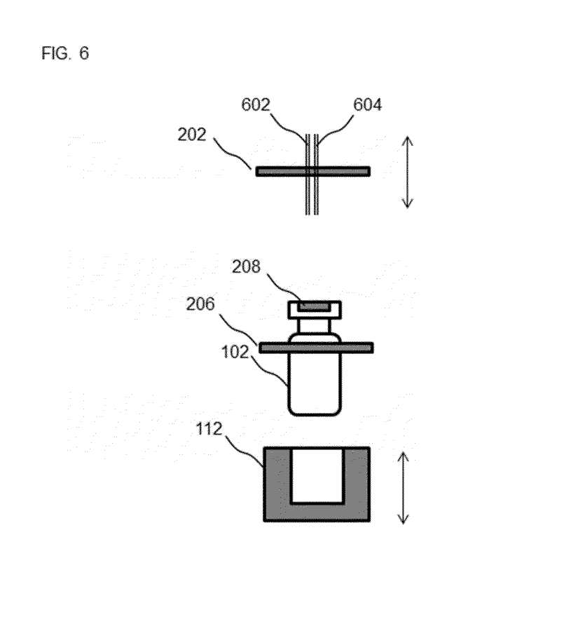

Referring to FIG. 6, the evaporating element 204 comprises a sealing member 202, an inlet needle 602, and an outlet needle 604. To dry, evaporate or concentrate the content in the reaction vessel 102, lower the sealing member 202 to seal the reaction vessel 102 and push the preconditioned temperature manipulating element 112 up to heat the reaction vessel 102, blow nitrogen (or other inert gas) through the inlet needle 602 and vent the reaction vessel through the outlet needle 604. Alternatively, vacuum may be applied through the outlet needle 604 to speed up the evaporating process. Charcoal may be placed in the vent line to trap the vent.

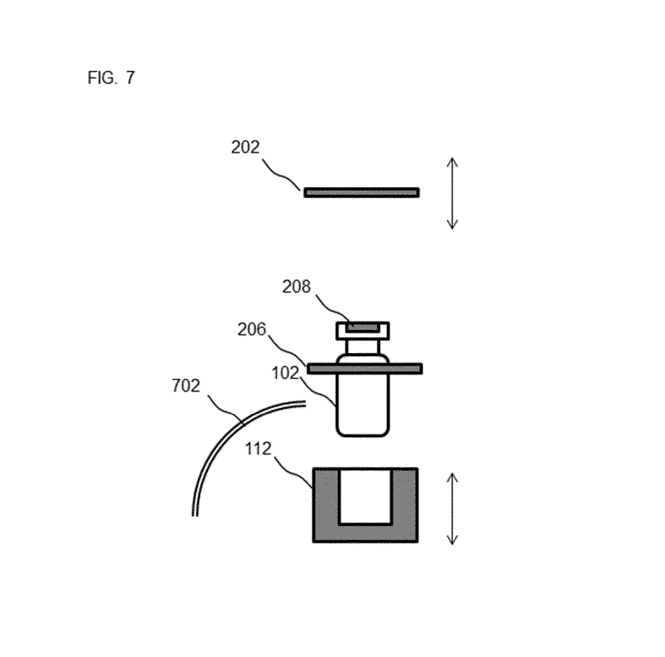

Referring to FIG. 7, a reaction element comprises a sealing member 202. To start a radiochemical reaction, lower the sealing member 202 to close the reaction vessel 102 and push the preconditioned temperature manipulating element 112 up to heat the reaction vessel 102. After the radiochemical reaction, lower the preconditioned temperature manipulating element 112 and cool the reaction vessel 102 with a cooling means 702 such as air or nitrogen gas while the reaction vessel 102 remains sealed.

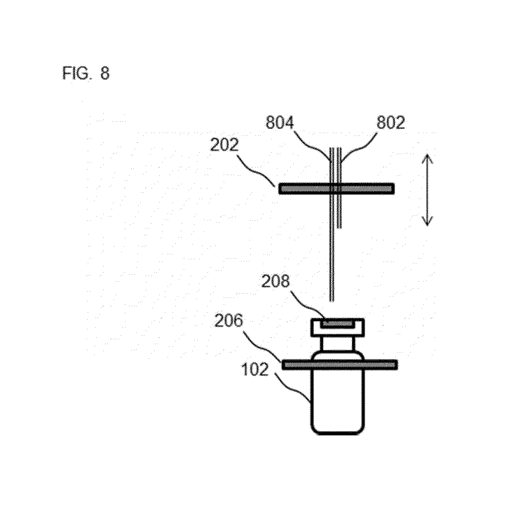

Referring to FIG. 8, the retrieving element 304 comprises a sealing member 202, an inlet needle 802 and an outlet needle 804. To retrieve a radioactive intermediate or a radiochemical product from the reaction vessel 102, lower the sealing member 202 to seal the reaction vessel 102, push nitrogen or other gas in through the inlet needle 802 and push the radioactive intermediate or the radiochemical product out through the outlet needle 804.

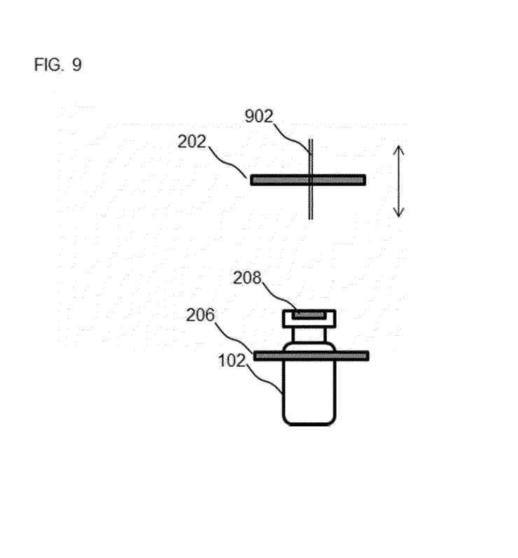

Referring to FIG. 9, the vessel removing element 402 comprises a sealing member and at least one needle 402. To remove the reaction vessel 102, unlock the reaction vessel 102, lower the sealing member 202 and let the at least one needle to pierce through the pierceable member 104. As the at least one needle 402 moves up, the reaction vessel 102 is removed from the first moving means 206. Alternatively, a gripper or similar device can be actuated to remove the reaction vessel 102.

The evaporation element 204, the filling element 302, the retrieving element 304, the reaction element (which comprises a sealing member 202) and the vessel removing element 402 are referred to below as the functional elements. Some of the functional elements may be modified or combined; or additional functional elements may be added.

Even though moving the reaction vessel 102 along a track is believed to be the best mode for present invention, the movement is relative—the preconditioned temperature manipulating elements 112 and the functional elements may be moved to reach the reaction vessel; or the reaction vessel 102, the preconditioned temperature manipulating elements 112 and the functional elements may be moved.

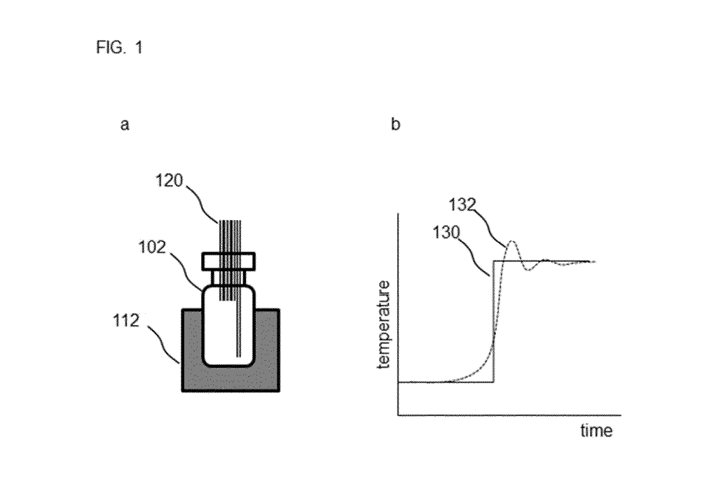

Additional moving means can be applied to mass transfer. Unlike the traditional multiline structure as illustrated in FIG. 1a, a moving means can accommodate at least one prefilled reagent vial and programmatically move the at least one prefilled reagent vial to a loading position, where the content in the at least one vial is loaded into the reaction vessel via at least one mass transfer line.

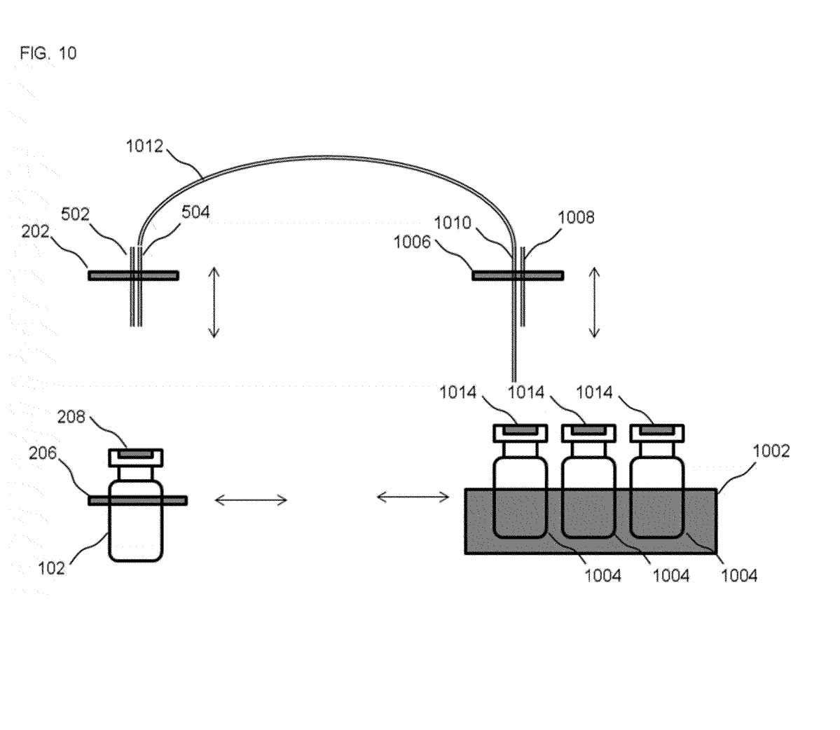

Referring to FIG. 10, an embodiment of the apparatus disclosed herein comprises an additional reagent stage. The reagent stage comprises a second moving means 1002, a sealing member 1006, an inlet needle 1008, and an outlet needle 1010. A mass transfer line 1012 connects the reagent stage and reaction stage. The second moving means 1002 accommodates at least one reagent vial 1004 prefilled with at least one reagent. The second moving means 1002 also moves the at least one reagent vial 1004 to a loading position, where the at least one reagent can reached by the outlet needle 1010 and transferred from the at least one reagent vial 1004 to the reaction vessel 102 through the outlet needle 1010, the mass transfer line 1012 and the inlet needle 504. Then the second moving means 1002, together with the at least one reagent vial 1004, can be removed.

The at least one reagent vial 1004 may be sealed with a pierceable member 1014 to make vial movement safe and secure, to reduce reagent loss and to prevent contamination.

As a result of the moving structure, the number of mass transfer lines can be reduced. The number of reagents can be increased or decreased depending on the degree of complexity of a radiochemical synthesis. Furthermore, the time-consuming and wasteful cleaning is not necessary considering both the reaction vessel and the reagent vial can be easily removed after a single use, suggesting the radiochemical apparatus can perform multiple runs a day.

The moving means 206 can be designed to move more than one reaction vessel 102 for parallel processes. The moving means can be further modified for other devices such as cartridges, filters and the like, which can be sequentially or programmatically positioned for reagent, intermediate and product treatment.

Although the present invention has been described in considerable detail with reference to certain preferred versions thereof, other versions are possible. Therefore, the spirit and scope of the appended claims should not be limited to the description of the preferred versions contained therein.

What is claimed is:

1. A radiochemical synthesis apparatus comprising
a reaction vessel positioned to receive a radioisotope and at least one reagent;
a plurality of temperature manipulation elements preconditioned and actuated to provide fast and stable heat transfer to the reaction vessel;
an evaporating element actuated to provide drying, evaporating or concentration needs;
a first moving means adapted to accommodate the reaction vessel and move the reaction vessel along a track to reach at least the plurality of temperature manipulation elements and the evaporating element, which are placed along the track;
whereby when heat is transferred to the reaction vessel from one of the plurality of temperature manipulation elements the content of the reaction vessel is dried, evaporated or concentrated; or when heat is transferred to the reaction vessel from another one of the plurality of temperature manipulation elements a radiochemical reaction is carried out, generating a radiochemical product or a radioactive intermediate; or when heat is transferred to the reaction vessel from yet another one of the of the plurality of temperature manipulation elements further radiochemical reaction is carried out, turning the radioactive intermediate into a radiochemical product.

2. Alternatively the plurality of temperature manipulation elements of claim 1 can be moved to reach the reaction vessel of claim 1.

3. The track of claim 1 can be straight, circular or other shape and the track of claim 1 can be visible or invisible.

4. The apparatus of claim 1 further comprising one or more filling elements placed along the track and actuated to fill the radioisotope or the at least one reagent into the reaction vessel.

5. The apparatus of claim 1 further comprising one or more retrieving elements placed along the track and actuated to retrieve the radioactive intermediate or the radiochemical product from the reaction vessel.

6. The apparatus of claim 1 further comprising a vessel removing element or the like placed along the track and actuated to remove the reaction vessel.

7. The apparatus of claim 1 further comprising at least one reagent vial, whereas the at least one reagent vial is prefilled with the at least one reagent.

8. The apparatus of claim 1 further comprising a second moving means adapted to accommodate the at least one reagent vial and to move the at least one reagent vial to a loading position to load the at least one reagent to the reaction vessel through at least one mass transfer line.

9. Both the reaction vessel and the at least one reagent vial may be sealed with a pierceable member and may be further sealed with a sealing member.

10. A method for producing a radiochemical product or producing multiple radiochemical products daily comprising the steps of
(a) preconditioning a plurality of temperature manipulation elements to the predetermined temperature before a reaction vessel is in heat transfer communication with the plurality of temperature manipulation elements;
(b) prefilling at least one reagent vial with at least one reagent before the reaction vessel is in mass transfer communication with the at least one reagent vial;
(c) accommodating the at least one reagent vial and moving the at least one reagent vial to a loading position;
(d) accommodating the reaction vessel and moving the reaction vessel to fill a radioisotope or fill the at least one reagent from the at least one reagent vial;
(e) moving the reaction vessel to reach one of the plurality of temperature manipulation elements, whereby the content in the reaction vessel is dried, evaporated or concentrated;
(f) moving the reaction vessel to reach another one of the plurality of temperature manipulation elements, whereby the radioisotope and the at least one reagent react to generate a radiochemical product or a radioactive intermediate;
(g) moving the reaction vessel to reach yet another one of the plurality of temperature manipulation elements, whereby the radioactive intermediate turns into a radiochemical product;
(h) retrieve the radiochemical product or the radioactive intermediate from the reaction vessel; and
(i) removing the reaction vessel and the at least one reagent vial.
